(19) United States
(12) Patent Application Publication
(10) Pub. No.: US 2003/0229150 A1
(43) Pub. Date: Dec. 11, 2003

(54) Methods for modifying high-shear rate properties of colloidal dispersions

(76) Inventors: Abbas A. Zaman, Gainesville, FL (US); Gary M. Freeman, Macon, GA (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/356,138

(22) Filed: Jan. 31, 2003

Related U.S. Application Data
(60) Provisional application No. 60/353,933, filed on Jan. 31, 2002.
(60) Provisional application No. 60/401,699, filed on Aug. 6, 2002.

(51) Int. Cl. B01F 3/00

(52) U.S. Cl. 516/9

(57) ABSTRACT

The subject invention provides advantageous methods for modifying high-shear rate properties of colloidal dispersions, such as kaolines and clays. The subject invention can be utilized to modify the high shear rate properties of colloidal dispersions having particles that need to be dispensed carrying a positive surface charge and/or particles that need to be dispersed having heterogeneous charges.

### CROSS-REFERENCE TO RELATED APPLICATION

This application claims the benefit of U.S. Provisional Application No. 60/353,933 filed Jan. 31, 2002 and U.S. Provisional Application No. 60/401,669, filed Aug. 6, 2002.

### BACKGROUND OF INVENTION

Stability and viscosity behavior of concentrated colloidal dispersions of solids is determined by the combined effects of different factors such as Brownian motion of the particles, hydrodynamic interactions, interparticle forces as well as physical characteristics of the particles such as particle size, particle size distribution, and shape of the particles (e.g, Russel, W. B., “The Rheology of Suspensions of Charged Rigid Spheres,” J. Fluid Mech. 85:209-232 (1978); Russel, W. B., “Review of the Role of Colloidal Forces in the Rheology of Suspensions,” J. Rheo. 24:287-317 (1980); Russel, W. B., Saville, D. A., and Schowalter, W. R., Colloidal Dispersions, 1991, Cambridge University Press, New York, N.Y.; Hunter, R. J., “Foundations of Colloid Science”, Vol. I and Vol. II, Oxford University Press, New York, 1995; Horn R. G. “Surface forces and their action in ceramic materials” J. Am. Ceramic Soc. 73:1117-1135 (1990)).

Colloidal dispersions are encountered in various industrial processes and in most of their applications they need to be stabilized against aggregation and agglomeration of the particles using stabilizing agents such as salt, surfactants, polymers, and polyelectrolytes. Particle-particle interactions arising from the adsorbed and dissolved polymers and surfactants as well as van der Waals attractive forces and electrostatic repulsive forces play a very significant role in governing stability and rheological behavior of colloidal dispersions.

In the processing of many industrial products, polymers are used as stabilizers or flocculants, which influence the flow behavior and structure of the suspension, depending upon the surface coverage, conformation and orientation of the adsorbed polymer on the particulate surface (e.g, Napper D. H., Polymeric stabilization of colloidal dispersions, Academic Press London 1983; Hashiba M., Sakurada O., Itho M., Takagi T., Hiramatsu K., and Nurishi Y. “Effectiveness of a dispersant for the thickening of alumina slurries whilst retaining the fluidity” J. Mater. Sci. 28:4456-4460 (1993); Rajaiah, J., Ruckenstein, E., Andrews, G. F., Forster, E. O., and Gupta, R. K., “Rheology of Sterically Stabilized Ceramic Suspensions” Ind. Eng. Chem. Res. 33:2336-2340 (1994); Marra, J. and Hair, M. L. “Forces between two poly (2-vinylpyridine)-covered surfaces as a function of ionic strength and polymer charge” J. Phys. Chem. 92:6044-6051 (1988); Biggs S., and Healy T. W. “Electrostatic stabilization of colloidal zirconia with low-molecular-weight polyacrylic acid—an atomic force microscopy study” J. Chem. Soc. Faraday Trans. 92:2783-2789 (1994); Pedersen H. G., and Bergstrom L. “Forces measured between zirconia surfaces in poly(acrylic acid) solutions” J. Am. Ceram. Soc. 82:1137-1145 (1999)).

Dispersions of fine particle kaolins have broad application in various industrial processes (e.g, Murray H. H. “Traditional and new application for kaolin, smectite, and palygorskite: a general overview” Applied Clay Science 17:207-221 (2000); Sjöberg, M., Bergström, L., Larsson, A. and Sjöström, E. (1999) “The effect of polymer and surfactant adsorption on the colloidal stability and rheology of kaolin dispersions” Colloid and Surfaces A, 159:197-208). The kaolinite crystal consists of altering layers of silica tetrahedra and aluminum octahedra and each particle consists of a stack of about 50 sheets of twin-layers held together with hydrogen bonds (e.g Carty W. M. (August 1999) “The colloidal nature of kaolinite” The American Ceramic Society Bulletin, pp 72-77; Herrington T. M., Clarke A. Q., and Watts J. C. “The surface charge of kaolin” Colloids and Surfaces 68:161-169 (1992)). The primary particles are peusdo-hexagonally shaped platelets and there is a significant difference in the chemical composition of the edges and the basal planes of the particles. There are often crystal imperfections in the kaolinite crystals, with ionic substitution of Al for Si or Mg for Al, which results in an overall deficit of positive charge (e.g, Brady, P. V. Cygan, R. T. and Nagy, K. L. (1996) “Molecular Controls on Kaolinite Surface Charge” Journal of Colloid and Interface Science, 183:356-364). This deficit of positive charge is addressed by the clay mineral through the adsorption of exchangeable cations, most notably Na⁺ and K⁺ ions, at levels of about 2-4 meq/100 g. The kaolin particles have negative surface charge on the basal plane and a pH dependent charge on the edge (e.g, Johnson, S. B. Russell, A. S. and Scales, P. J. (1998) “Volume fraction effects in shear rheology and electroacoustic studies of concentrated alumina and kaolin suspension” Colloids and Surfaces A, 141:119-130; Zbik M., and Smart R. ST.C.:Nanomorphology of kaolinites: comparative SME and AFM studies” Clays and Clay Minerals 46(2):153-160 (1998)). Adsorption of dispersing agents on kaolin is complex due to the heterogeneous character of the clay surface. Due to the presence of heterogeneously charged edges and faces constituting the particle, kaolin has a complicated surface chemistry (Brady, P. V. Cygan, R. T. and Nagy, K. L. (1996) “Molecular Controls on Kaolinite Surface Charge” Journal of Colloid and Interface Science, 183:356-364).

Kaolin edges contain both silica and alumina-like sites, which are positively, charged at low pH, but progress through an isoelectric point to possess a negative charge at high pH. This pH dependent behavior is largely due to the Bronsted acid/base behavior of the aluminum hydroxyl groups located at the edges. The kaolin face contains only silica-like charge sites and remains negatively charged across the pH range (Johnson, S. B. Russell, A. S. and Scales, P. J. (1998) “Volume fraction effects in shear rheology and electroacoustic studies of concentrated alumina and kaolin suspension” Colloids and Surfaces A, 141:119-130 and Johnson, S. B., Franks, V. G., Scales, P. J., Boger, V. D. and Healy, W. T. (2000) “Surface chemistry-rheology relationships in concentrated mineral suspension” Int. J. Miner. Process 58:267-304). Since the isoelectric points of silica and alumina are in pH ranges of 2.0-3.5 and 8.5-10.4 respectively (Carty, W. M. (August 1999) “The colloidal nature of kaolinite” The American Ceramic Society Bulletin, pp 72-77), in the pH range of 3.5-9.5, the basal plane of kaolin is negatively charged and the alumina like charged sites on the edge must be positively charged.

In the absence of dispersing agents, particle-particle interactions between the edges and the basal planes of the kaolinite particles gives rise to electrostatic edge-to-face attraction, leading to the build up of a “card house” type structure (Johanson et al. 1999; Jogun S. M. and Zukoski C. F., Rheology and microstructure of dense suspensions of plate-shaped colloidal particles, J. Rheol. 43(4), 847-871 (1999)) that promotes aggregation of the particles in the dispersions. Adsorption of polymers or surfactants onto the surface of the particles will affect these interactions altering stability and flow behavior of the dispersion (e.g, Sjöberg, M., Bergström, L., Larsson, A. and Sjöström, E. (1999) The effect of polymer and surfactant adsorption on the colloidal stability and rheology of kaolin dispersions. Colloid and Surfaces A, 159 197-208). Also, as the pH of the dispersion is increased, when the edge of the particles assumes a similar charge as the basal planes, the structure collapses and the electrostatic repulsion due to high negative surface charge between the particles causes dispersion.

To prepare highly concentrated kaolin slurries of controlled fluidity and stability, one needs to control the surface interaction of kaolin through the addition of dispersing agents. Adsorption of polymers as a function of pH, ionic strength, and polymer charge, on the surface of kaolin has been studied in the past (e.g, Sastry, N. V., Sequaris J.-M., and Schwuger M. J. (1994) Adsorption of polyacrylic Acid and Sodium Dodecylbenzenesulfonate on kaolinite, Journal of Colloid and Interface Science 171, 224-233; Lee, D. H., Condrate, R. A. Sr. and Reed, J. S. (1996) Infrared spectral investigation of polyacrylate adsorption on alumina. Journal of Material Science, 31, 471-478).

Negatively charged polymers are used as common dispersing agents to prepare highly concentrated (as high as 72% solids by weight) dispersions of kaolin particles for paper coatings. Using attenuated total reflection infrared Fourier transfer (FT-IR/ATR) spectroscopy in combination with adsorption experiments using the depletion method, Zaman et al. (Zaman A. A., Tsuchiya R. and Moudgil B. M., Adsorption of a Low Molecular Weight Polyacrylic Acid on Kaolin: Infrared Spectroscopy and Adsorption Studies, in Review, JCIS (2001)) have recently shown that a negatively charged polymer such as polyacrylic acid adsorbs on alumina like charge sites present on the edge of kaolin particles.

In applications such as paper coatings, the solids content of the clay dispersion used for formulation can be as high as 72% solid (wt) which often causes severe problems with handling and subsequent application due to dilatancy phenomena under the high speed of paper-coating machines where shear rates between 10⁵ to 10⁶ s⁻¹ are common (e.g, Ghosh T., (1998) Rheology of kaolin-based pigment slurries and the coating colors they form, Part I, Tappi Journal 81(5), 89-92 and Part II, Tappi Journal 81(5), 123-126). The challenge is to create a uniform and defect-free layer of coating of 10-15 μm thickness from the high shear flow produced under the coating blade of the paper-coating machine. This requires a basic understanding of the influence of different additives on the runnability of the slurry to develop a proper coating formula to not only keep the particles well dispersed, but to keep the slurry stable at high shear rates to prevent shear-induced flocculation of the particles, dewatering under the coating blade and related problems at these processing conditions.

### BRIEF SUMMARY OF THE INVENTION

The subject invention provides advantageous methods for modifying high-shear rate properties of colloidal dispersions, such as kaolins and clays. The subject invention can be utilized to modify the high shear rate properties of colloidal dispersions having particles that need to be dispersed carrying a positive surface charge and/or particles that need to be dispersed having heterogeneous charges. Specifically exemplified is a method for increasing the solids content in a colloidal dispersion.

In a preferred embodiment, the present invention provides a method for modifying the rheological properties of colloidal dispersions with positively charged edges, or heterogeneously charged geometric faces and edges. Advantageously, the methods of the subject invention can be used to reduce the high shear rheology of high solids colloidal dispersions, such as, for example, kaolin clay slurries. Advantageously, by the addition of two chemically distinct dispersing agents, the colloidal dispersion viscosity decreases at high shear rates.

The methods of the subject invention can be applied to a variety of dispersions including, but not limited to, dispersions of kaolin clays, calcium carbonates, silica particles, alumina particles, zirconia particles, bentonite clays, laponite clays, and montmorilonite clays.

In a preferred embodiment of the method of the subject invention, two dispersing agents are added as a mixture of a polymer, which adsorbs onto the edges of the colloidal dispersion, and a surfactant. In a specific embodiment of the subject invention a polyacrylate polymer, such as sodium polyacrylate, is utilized in conjunction with an anionic surfactant such as sodium dodecylbenzenesulfonate. The polyacrylate adsorbs onto the edges of the colloid particles, and the anionic surfactant remains in the colloidal medium. As a result, the viscosity decreases, and in turn, the shear thickening at the boundary decreases. One practical application for modifying these rheological properties is increased solids content in process streams.

### BRIEF SUMMARY OF THE FIGURES

FIG. 1 is plot of the adsorption density of sodium polyacrylate onto kaolin as a function of polyacrylate concentration.

FIG. 2 is a plot of the adsorption density of sodium polyacrylate onto kaolin as a function of pH.

FIG. 3 is a plot of the adsorption density of sodium dodecylbenzenesulfonate as a function of sodium dodecylbenzenesulfonate concentration.

FIG. 4 is a plot of the viscosity of 70% wt solids kaolin dispersion at two different shear rates as a function of sodium polyacrylate dosage.

FIG. 5 is a plot of the viscosity of 70% wt solids kaolin dispersion at two different shear rates as a function of sodium dodecylbenzenesulfonate dosage.

FIG. 6 is a plot of the viscosity of 67% wt solids kaolin dispersion dosed with sodium dodecylbenzenesulfonate or sodium polyacrylate as a function of shear rate.

FIG. 7 is a plot of viscosity of 68% wt solids kaolin dispersion as a function of shear rate for four different sodium dodecylbenzenesulfonate and sodium polyacrylate mixtures.

FIG. 8 is a plot of viscosity of 70% wt solids kaolin dispersion as a function of shear rate for five different sodium dodecylbenzenesulfonate and sodium polyacrylate mixtures.

FIG. 9 is a plot of 70% wt solids kaolin dispersion with pre-adsorbed sodium polyacrylate at a shear rate of 100 s⁻¹ as a function of sodium dodecylbenzenesulfonate dosage.

FIG. 10 is a plot of viscosity of 70% wt solids kaolin dispersion with pre-adsorbed sodium polyacrylate at a shear rate of 5,000 s⁻¹ as a function of sodium dodecylbenzenesulfonate dosage.

FIG. 11 is a plot of viscosity of 70% wt solids kaolin dispersion with pre-adsorbed sodium polyacrylate at a shear rate of 20,000 s⁻¹ as a function of sodium dodecylbenzenesulfonate dosage.

FIG. 12 is a plot of Smoluchowski zeta potential for 5% wt solids kaolin dispersion with a fixed dosage of sodium polyacrylate as a function of pH.

FIG. 13 is a plot of Smoluchowski zeta potential for 5% wt solids kaolin dispersion with a fixed dosage of sodium polyacrylate as a function of sodium dodecylbenzenesulfonate and pH.

FIG. 14 is a surface plot of viscosity of 70% wt solids kaolin dispersion at a shear rate of 100 s⁻¹ as a function of sodium dodecylbenzenesulfonate and sodium polyacrylate dosages.

FIG. 15 is a contour plot of the viscosity of 70 wt % solids kaolin dispersion at a shear rate of 100 s⁻¹ as a function of sodium polyacrylate and sodium dodecylbenzene dosages.

FIG. 16 is an interaction plot for the effects of sodium polyacrylate and sodium dodecylbenzenesulfonate on the viscosity of 70% wt solid kaolin dispersion at a shear rate of 100 s⁻¹.

FIG. 17 is a surface plot of the viscosity of 72% wt solid kaolin dispersion at a shear rate of 100 s⁻¹ as a function of sodium polyacrylate and sodium dodecylbenzenesulfonate dosages.

FIG. 18 is a contour plot of the viscosity of a 72% wt solids kaolin dispersion at a shear rate of 100 s⁻¹ as a function of sodium polyacrylate and sodium dodecylbenzenesulfonate.

FIG. 19 is an interaction plot for the effects of sodium polyacrylate and sodium dodecylbenzenesulfonate on the viscosity of 72% wt solid kaolin dispersion at a shear rate of 100 s⁻¹.

FIG. 20 is a surface plot of the viscosity of 72% wt solid kaolin dispersion at a shear rate of 5000 s⁻¹ as a function of sodium polyacrylate and sodium dodecylbenzenesulfonate dosages.

FIG. 21 is a contour plot of the viscosity of 72% wt solids kaolin dispersion at a shear rate of 5000 s⁻¹ as a function of sodium polyacrylate and sodium dodecylbenzenesulfonate.

FIG. 22 is an interaction plot for the effects of sodium polyacrylate and sodium dodecylbenzenesulfonate on the viscosity of 72% wt solid kaolin dispersion at a shear rate of 5000 s⁻¹.

### DETAILED DESCRIPTION OF INVENTION

The subject invention provides advantageous methods for modifying high-shear rate properties of colloidal dispersions, such as kaolines and clays. The subject invention can be utilized to modify the high shear rate properties of colloidal dispersions having particles that need to be dispersed carrying a positive surface charge and/or particles that need to be dispersed having heterogeneous charges.

In a specific embodiment, the high-shear rate properties of colloidal dispersions can be modified in accordance with the subject invention by the addition of a dispersing composition to the colloidal particles wherein the dispersing composition comprises both an adsorbing polymer and an anionic surfactant. As used herein an “adsorbing polymer” refers to a polymer that adsorbs to the particles of the colloidal dispersion. In a preferred embodiment, the polymer is a polyacrylate. Specifically exemplified herein are low molecular weight (3,000-4,000) polyacrylate polymers such as, for example, Colloid-211 available from Vinings.

Anionic surfactants are well known to those skilled in the art and typically are characterized as being negatively charged surface-active agents. Specifically exemplified herein is sodium dodecylbenzene sulphonate (SDBS). Colloidal dispersions for which the high shear rate properties can be modified in accordance with the subject invention include, for example, kaolines, calcium carbonate, silica particles, alumina particles, zirconia particles, and clays such as bentonite, laponite, and montmorilonite. Specific examples of the subject invention can utilize amounts of the dispensing agent and the ratios of Na-PAA-to-SDBS described in the following Examples and Figures.

By using mixed dispersing agents derived from different chemistries, advantageous effects on the viscosity and stability behavior of kaolin dispersions (fine particle, narrow distribution coating clays) can be made to achieve slurries of high solids content with acceptable fluidity and stability under extreme conditions (high shear flows, confined geometries, narrow gaps). Clay dispersions exhibit a maximum in viscosity at high shear rates responsible for failures in coating processes. In accordance with the subject invention, the high shear flow properties of electrosterically stabilized kaolin dispersions of neutral pH can be improved through the addition of a small amount of a negatively charged surfactant to the system. While samples prepared using a low molecular weight Na-PAA can exhibit shear thickening behavior at high shear rates, the magnitude of shear thickening can be reduced in dispersions prepared using Na-PAA/anionic surfactant as mixed dispersing agents. The viscosity behavior of kaolin dispersions can be optimized with respect to the total dispersing agent dosage and the ratio of the two dispersing agents. In a specific embodiment, rheological behavior and the onset of shear thickening of Huber kaolin dispersions as a function of dispersing agents dosage, and ratio of the dispersants can be controlled in accordance with the subject invention. Accordingly, the subject invention relates to optimizing the formulation for kaolin slurries under a variety of extreme conditions.

The methods of the subject invention can be practiced by simultaneous or sequential addition of the dispersing agents to the colloidal dispersion. In the case of simultaneous addition, the agents may be separate or already combined. Accordingly, in one embodiment the subject invention provides a kit having both agents. In one embodiment the agents are in separate containers. In another embodiment the agents are pre-mixed. In either case the kit preferably includes instructions regarding the use of the agents (the polymer and surfactant) to increase solids content of a colloidal dispersion, or otherwise modify the Theological properties of a dispersion.

In a specific embodiment, the subject invention relates to the use of a mixture of surfactant, preferably an anionic one, and a sodium polyacrylate dispersant for the purpose of reducing the high shear rheology of high solids kaolin clay slurries. The process involves dispersing the neutralized clay slurries of pH 7.0+/−0.5 with sodium polyacrylate dispersants, such as Colloid-211 manufactured by Vinings. Sodium polyacrylate dispersants of low MW (3,000-4,000) are already commonly used as secondary dispersants in kaolin clay processing. Neutralization of the clay slurry is commonly achieved through the addition of soda ashe. In the subject method, an anionic surfactant (such as Sodium Dodecylbenezenesulfonate; denoted SDBS) is mixed with the sodium polyacrylate dispersant at certain optimum weight ratios to yield high solids kaolin clay slurries with noted improvements in their high shear rheology. Improvements in high shear rheology with respect to the subject clay system, Covergloss slurry, were observed at shear rates above 10,000 cm⁻¹. A preferred dispersant/surfactant mixture seems to be about 2 mg dispersant/g of dry clay with 2-5 mg surfactant/g of dry clay.

All patents, patent applications, provisional applications, and publications referred to or cited herein are incorporated by reference in their entirety, including all figures and tables, to the extent they are not inconsistent with the explicit teachings of this specification.

### Materials and Methods

Kaolin

The acid-dried kaolin material used in this example was acquired from the Engineered Materials Division of J.M. Huber Corporation, which was identified to be one of Huber's fine particle, narrow distribution coating clays currently used in the paper industry. The kaolin powder was delivered with a primary dispersing agent, sodium silicate, as needed to process the kaolin crude through its various water wash beneficiation steps. The beneficated clay was then mechanically dewatered using a vacuum filter employing a combination of sulfuric acid and alum as filtration aides where after the clay filter cake material, in acid form, was dried for subsequent use. The use of a primary dispersant for blunging of the clay crude and its subsequent processing followed by the addition of a secondary dispersant after the vacuum filtration process is in accordance with commercial kaolin processing practices.

The BET nitrogen-specific surface area of the supplied kaolin powder was measured using a Quanta Chrome NOVA 1200 instrument and found to be 16.9 m².g⁻¹. Density of the powder was measured using a Quanta Chrome Ultrapycnometer and found to be 2.67 g.cm⁻³ while the kaolin's median particle size was 0.5 microns as determined by sedimentation from the application of Stokes Law using a Micromeritics' Sedigraph 5100 particle size analyzer. The sodium salt of a low molecular weight polyacrylic acid (MW=3,400, polydispersity index=1.18 and 43.1% solids provided by Vinings Industries Inc.) and Sodium Dodecylbenzenesulfonate (SDBS) were used as the dispersing agents. The ultra pure water (Millipore) of specific resistively greater than 18 MΩcm⁻¹ was used to prepare the solutions in this example. All experiments were performed at a pH of 7.5 and an industrial grade Na₂CO₃ was used as the pH modifier.

Adsorption Measurements

All adsorption experiments were conducted at room temperature (25° C.) using suspensions with a total volume of 10 cm³ contained in 30 cm³ polyethylene screw-capped bottles. Depending upon the volume fraction of particles and the dispersing agent dosage, the Na-PAA and SDBS surfactant stock solutions were diluted with ultra pure water to the desired concentration and used as the suspending fluid. The required mass of dry particles was then slowly added to the suspending fluid. After addition of the particles, the suspensions were then agitated for three minutes and left on a Burrell Model 75 Wrist Shaker for a period of at least 17 hours in order for equilibrium to be reached. For adsorption studies, after equilibration, the samples were centrifuged for 15 minutes at 15,000 rpm and the supernatant carefully withdrawn. The supernatant was allowed to sit overnight in a refrigerator to allow the settling of any remaining particles, as testing had shown that a few particles could still be present after the centrifugation process, the presence of which could adversely affect subsequent analysis. The residual Na-PAA concentration was then determined using a Tekmer-Dorhmann Phoenix 8000 Total Organic Carbon (TOC) analyzer. The experimentally measured nitrogen BET surface area was used in conducting the adsorption isotherms.

The viscosity of the kaolin slurry samples was determined using a Paar Physica UDS 200 rheometer with cone-and-plate and parallel-plate geometries. All experiments were performed at 25° C. and the sample temperature was controlled to within ±0.1° C. using water as the heat transfer fluid. The cone-and-plate geometry was employed to measure the viscosity of the samples of solids contents lower than 50% wt solids and the parallel-plate geometry was employed for samples of higher solids content. A cone of radius 3.75 cm with a cone angle of 1.0° (a gap size of 50 μm) and a plate of radius 2.5 cm were used to perform the viscosity measurements. The possibility of sedimentation of the particles and water evaporation from the samples during experiments was examined by performing viscosity measurements as a function of time at a fixed shear rate. The results did not change over the time period of the experiments. Also, the viscosity values measured using two different geometries on the same sample agreed within experimental error (±3%).

It should be understood that the embodiments described herein are for illustrative purposes only and that various modifications or changes in light thereof will be suggested to persons skilled in the art and are to be included within the spirit and purview of this application.

### EXAMPLE 1

### Adsorption

When two different-dispersing agents are added to the dispersions of particles with different adsorption sites such as kaolin, at least three distinguished types of adsorption behavior may be observed (Tom L. H., Keizer A. de, Koopal L. K., Blokzijl W., and Lyklema et al. Polymer adsorption on a patchwise heterogeneous surface, Progr Colloid Polym Sci 109, 153-160 (1998)). The first type of mixed adsorption can take place if the two components compete for the same adsorption sites resulting in adsorption of one of the components while the other one stays in the solution (competitive adsorption). The second type is cooperative adsorption meaning one of the components adsorbs on the surface and the second component on the top of first one. The third one is independent adsorption, which occurs if the two components adsorb to different adsorption sites, for example in the case of kaolin; one adsorbs on the basal planes and the second one adsorbs on the edges of the particles independently. The polymer and surfactant used in this example are both negatively charged implying that these dispersing agents will compete for the same adsorption sites at the surface of the particles.

Adsorption of Na-PAA

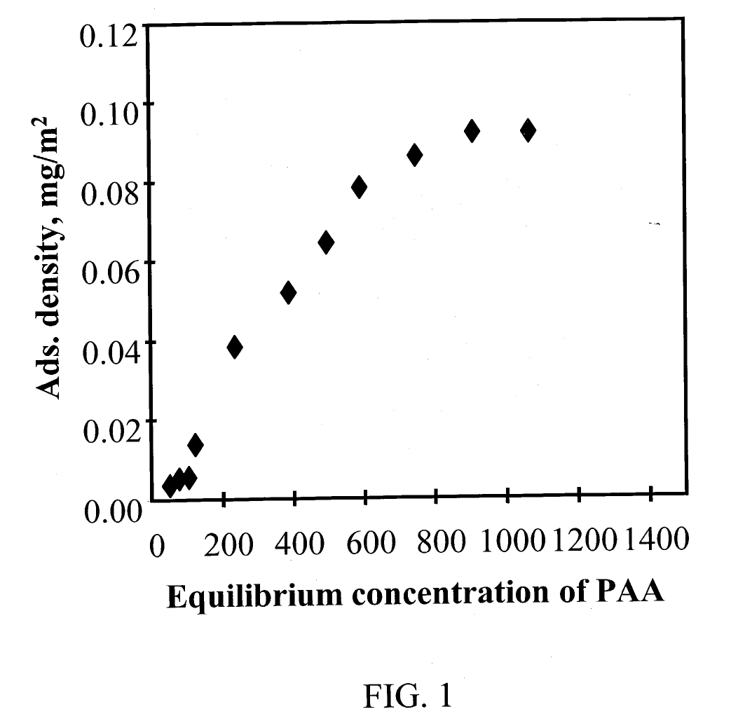

FIG. 1 represents the adsorption isotherm of 3,400 MW Na-PAA on the surface of the kaolin particles at pH=7.5. The maximum adsorbed amount is nearly equal to 0.09 mg.m² which appears to be larger than the results of Sjöberg and co-workers (Sjöberg, M., Bergström, L., Larsson, A. and Sjöström, E. (1999) The effect of polymer and surfactant adsorption on the colloidal stability and rheology of kaolin dispersions. Colloid and Surfaces A, 159 197-208), who obtained a plateau value of 0.035 mg.m⁻² for the adsorption of 4500 MW Na-PAA on the surface of kaolin at a pH level of 8.5.

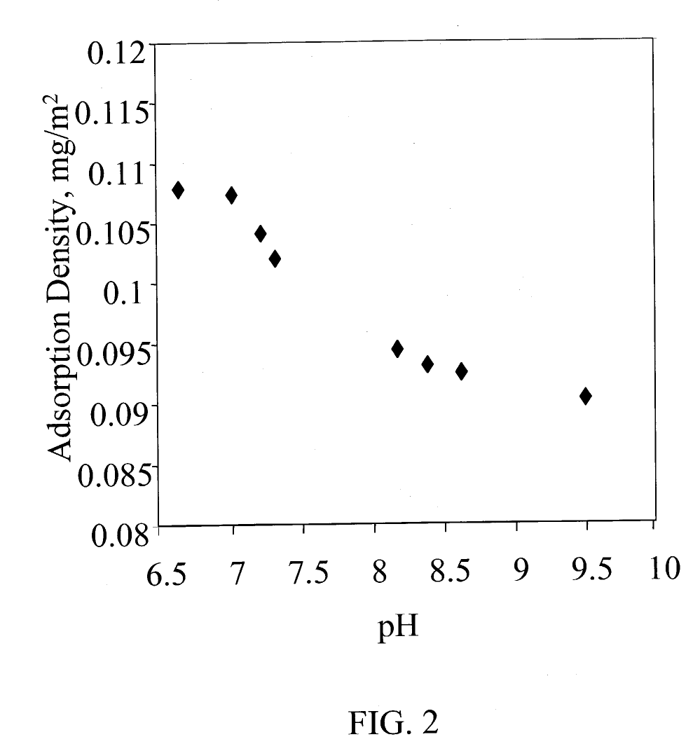

At low equilibrium concentrations, the adsorption rises steeply indicating a high affinity type adsorption. FIG. 2 is a plot of adsorption density of PAA on the surface of the kaolin particles as a function of pH. Aspect ratio of the particles, purity of the powder, and the concentration of multivalent ions are other factors that significantly affect the adsorption of the polymer on the surface of the kaolin particles.

Adsorption of SDBS Anionic Surfactant

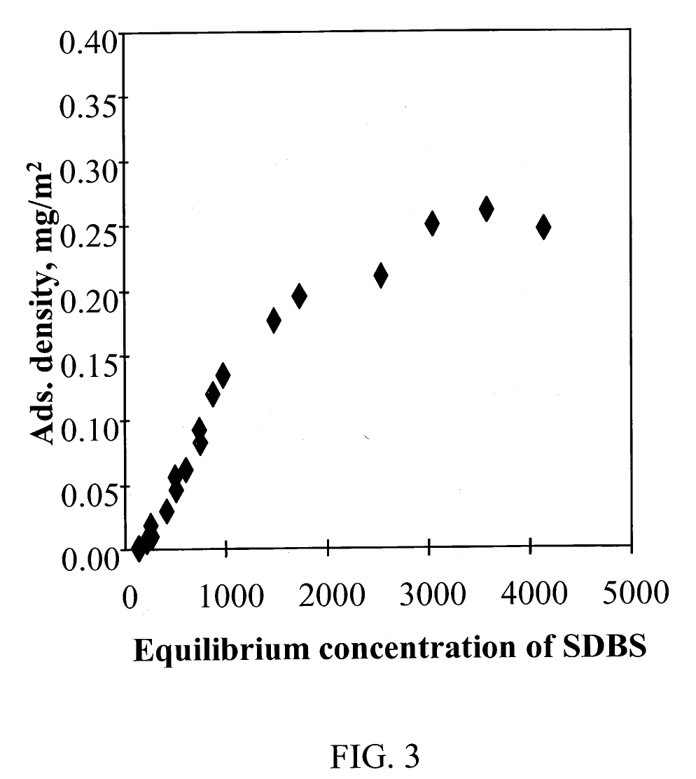

Adsorption of the anionic surfactant sodium dodecylbenzene sulphonate (SDBS) in the absence of Na-PAA is presented in FIG. 3 which is a plot of adsorption density as a function of equilibrium concentration of surfactant in supernatant at pH=7.5. The maximum adsorbed amount of SDBS on this grade of kaolin is approximately equal to 0.24 mg.m⁻¹. Sjoberg et al. (Sjöberg, M., Bergström, L., Larsson, A. and Sjöström, E. (1999) The effect of polymer and surfactant adsorption on the colloidal stability and rheology of kaolin dispersions. Colloid and Surfaces A, 159 197-208) has reported a value of 0.18 mg.m⁻² for the saturation adsorption of SDBS on the surface of kaolin particles at a pH level of 8.5. Their results indicate that when Na-PAA is present in the system, both polymer and surfactant will compete for the same adsorption sites on the surface of the kaolin particles.

### EXAMPLE 2

### Effects of Na-PAA and SDBS Dosages on the Viscosity of Kaolin Dispersions

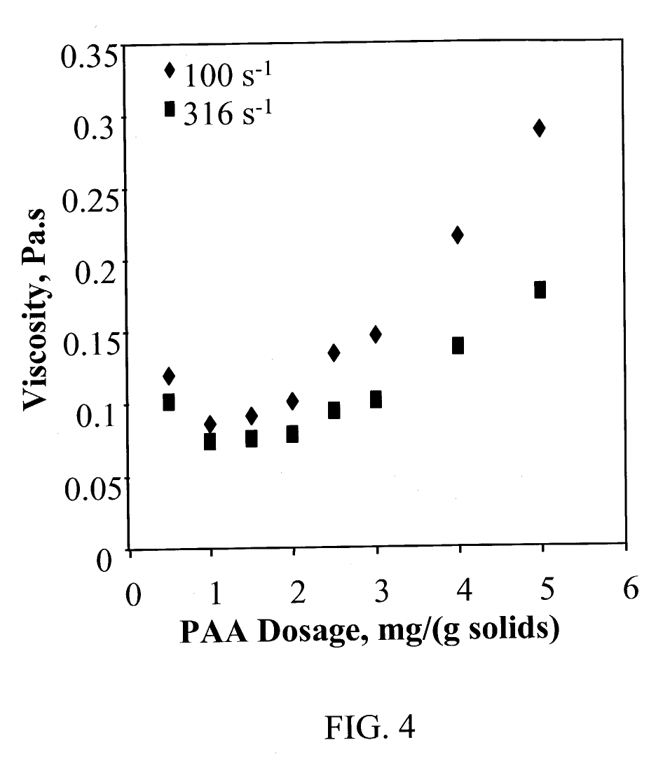

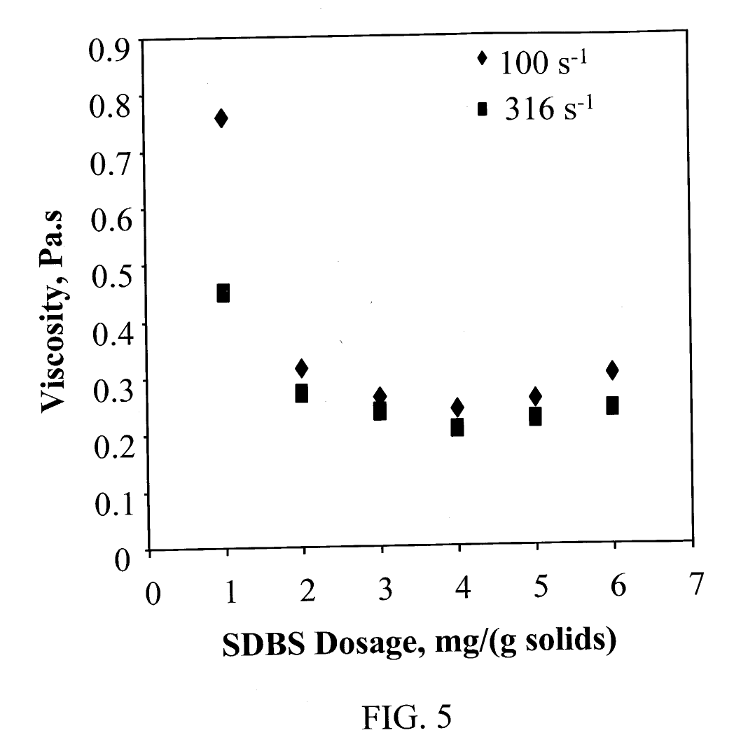

Effect of Na-PAA and SDBS dosages on the viscosity of dispersions of Huber kaolin particles at 70% wt solids is shown in FIGS. 4 and 5 which represent viscosity as a function of polymer and SDBS dosages respectively at shear rate levels of 100 s⁻¹ and 316 s⁻¹. The viscosity of the suspensions initially decreases to a minimum with increasing the polymer and surfactant dosages and then starts to increase gradually with further addition of polymer or surfactant to the suspension. Critical concentrations of the polymer and surfactant that need to be added to the dispersion to yield minimal viscosities are equal to 2 mg/(g solids) and 4 mg/(g solids) respectively.

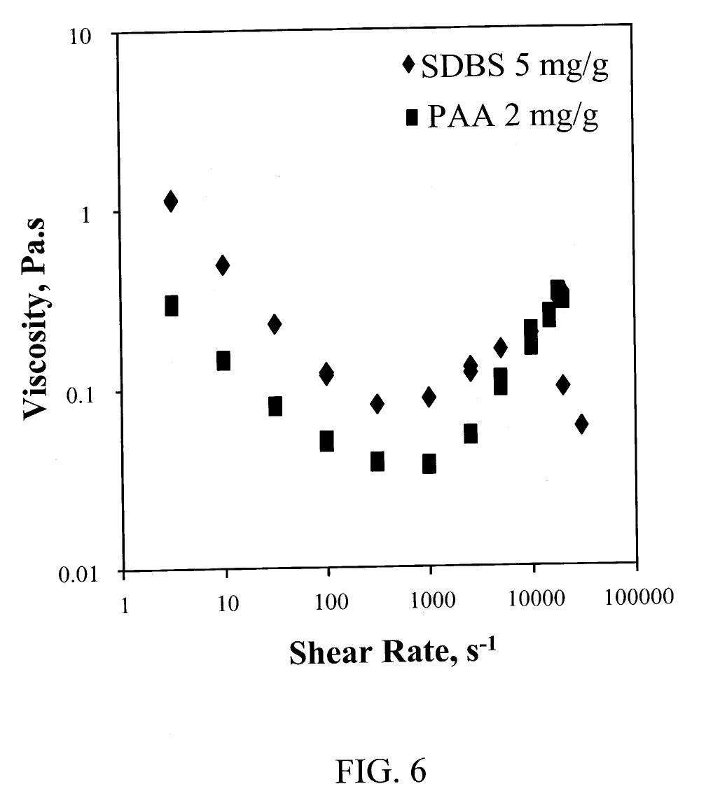

The data indicate that at low to intermediate shear rates, samples prepared in the presence of surfactant show higher viscosity levels that the samples prepared using Na-PAA as the only dispersing agent. Despite the presence of a primary dispersing agent, the addition of polymer or surfactant to the kaolin dispersion significantly improves the viscosity behavior of the system. However, higher percentages of relative viscosity reduction would be expected if they were used with pure kaolin powders having no primary dispersing agent. FIG. 6 represents the effect of shear rate on the viscosity of two kaolin dispersions at 67% wt solids, one prepared using 2 mg/(g solids) Na-PAA and the other using 5 mg/(g solids) SDBS as dispersing agents. Even though the surfactant stabilized sample shows higher levels of viscosity at the low shear rates, the trend is reversed at high shear rates. It appears that dilatancy (shear thickening) is reduced when surfactant is used as a stabilizing agent and also in this case lower viscosities are observed after the onset of shear thickening.

Due to heterogeneity of the charge on the surface of kaolin particles, in the absence of dispersing agents, interactions between the edges and the basal planes promote aggregation of the particles into edge-to-edge, edge-to-face, or face-to-face structures causing a significant increase in the viscosity of the dispersion even at very low volume fraction of the particles. Adsorption of Na-PAA, SDBS, and other anionic dispersing agents onto the positive sites of the surface of the particles prevents structure formation resulting in a well-dispersed slurry of low viscosity.

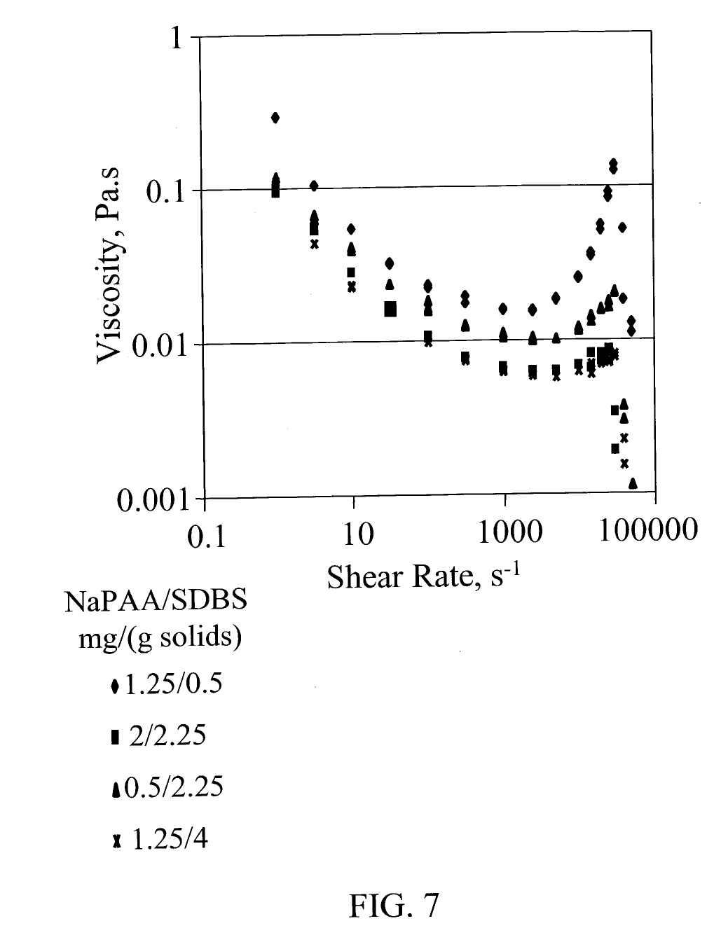

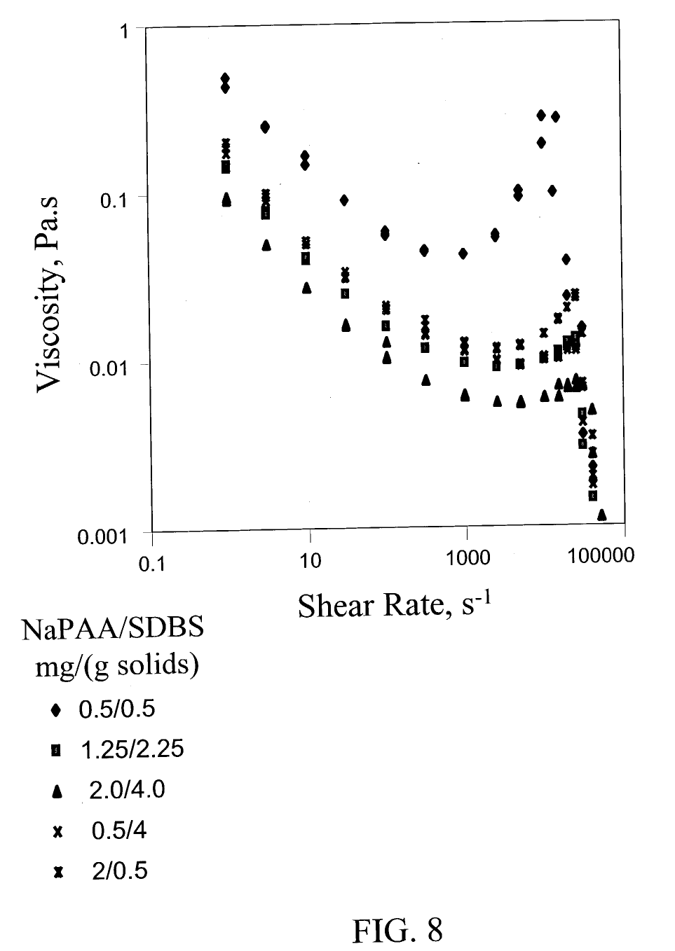

FIGS. 7 and 8 represent the viscosity data as a function of shear rate, dosage, and ratio of Na-PAA/SDBS for dispersions of Huber kaolin at 68% wt solids and 70% wt solids respectively. The viscosity of the dispersion is highly affected by both dosage and the ratio of the two dispersing agents used to prepare the slurry. Results indicate that by changing the dosage and the ratio of the two dispersing agents one can control the viscosity behavior of kaolin dispersions. The onset of shear thickening is shifted to higher shear rates when the dosage of the polymer and surfactant is increased in the system. From the data given in these figures it appears that there are several combinations of Na-PAA/SDBS for which the dilatancy of the dispersion is significantly reduced.

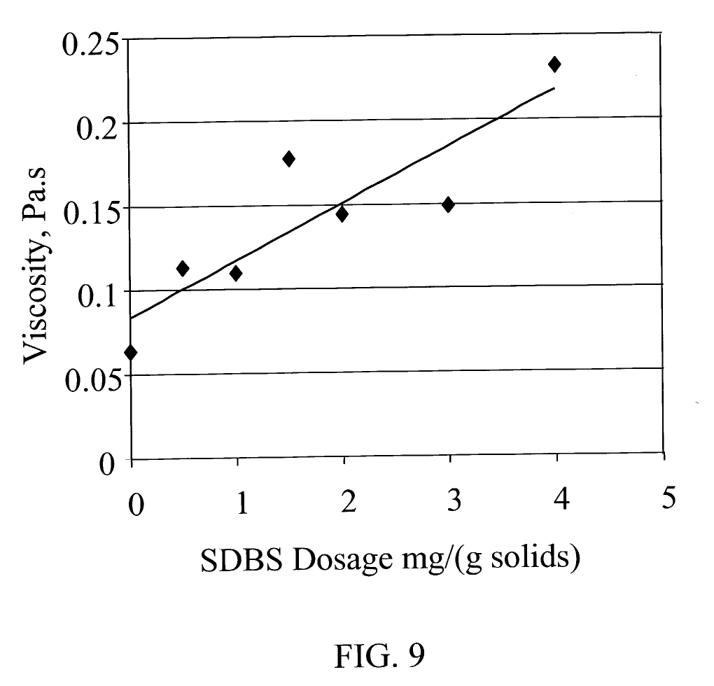

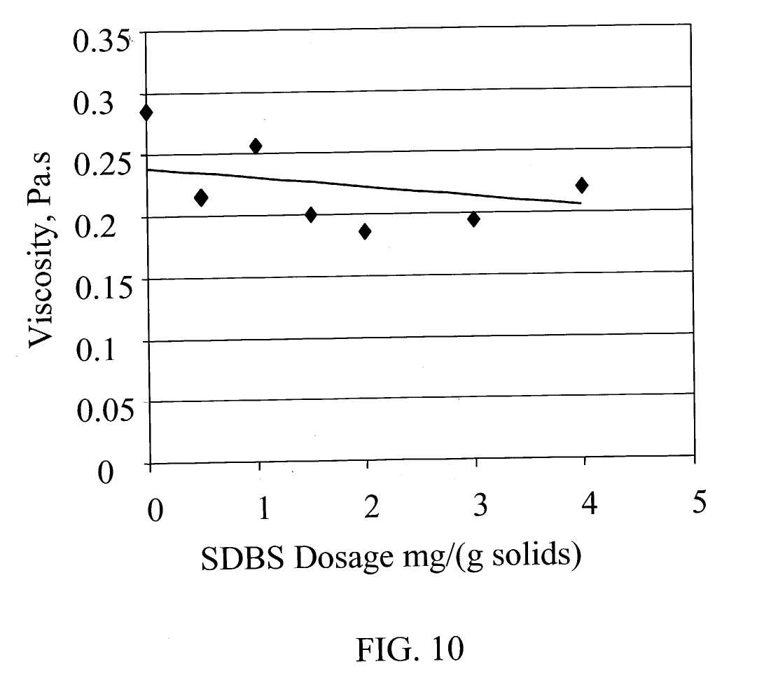

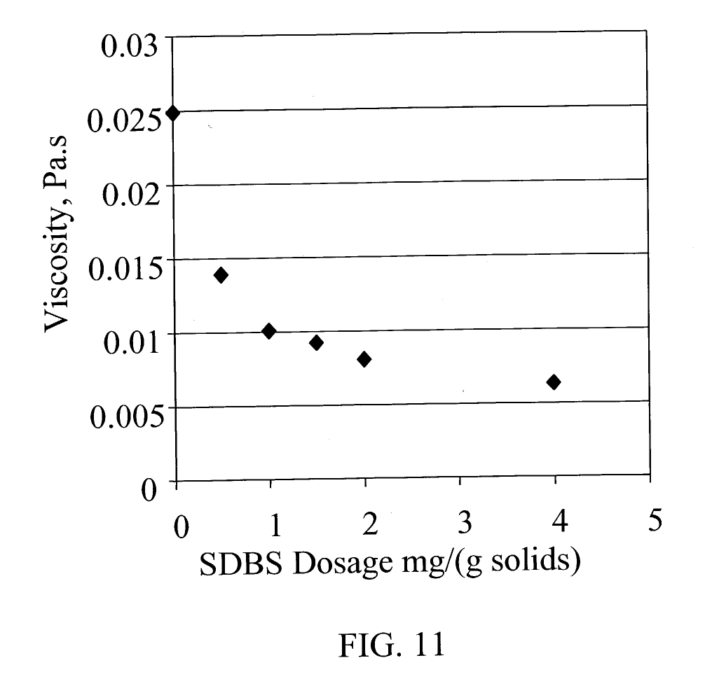

To study the effect of SDBS on the viscosity of the samples at a fixed dosage of the polymer, a set of dispersions of kaolin particles (7 samples) with pre-adsorbed Na-PAA (prepared using 2 mg/(g solids) Na-PAA) were treated with SDBS solutions of different concentrations such that all slurries had a final solids content of 70% wt, but different SDBS concentrations. As indicated in FIGS. 9 through 11, the viscosity response of the dispersion to SDBS dosage is shear rate dependent. From the data determined at lower shear rates, the viscosity of the dispersion increases through the addition of SDBS surfactant to the system. In contrast, the trend is reversed at higher shear rates whereby the viscosity of the dispersion decreases as the SDBS dosage is increased in the system.

It should be noted that the viscosity response of the kaolin dispersion to the dosage of SDBS varies with the existing dosage of Na-PAA in the dispersion. FIGS. 9 through 11 represent the viscosity data for conditions that presumably all adsorption sites on the surface of kaolin particles are covered with PAA/primary dispersing agent molecules and therefore most of the added SDBS may remain free in the suspending media.

### EXAMPLE 3

### Colloidal Stability and Electrokinetic Properties

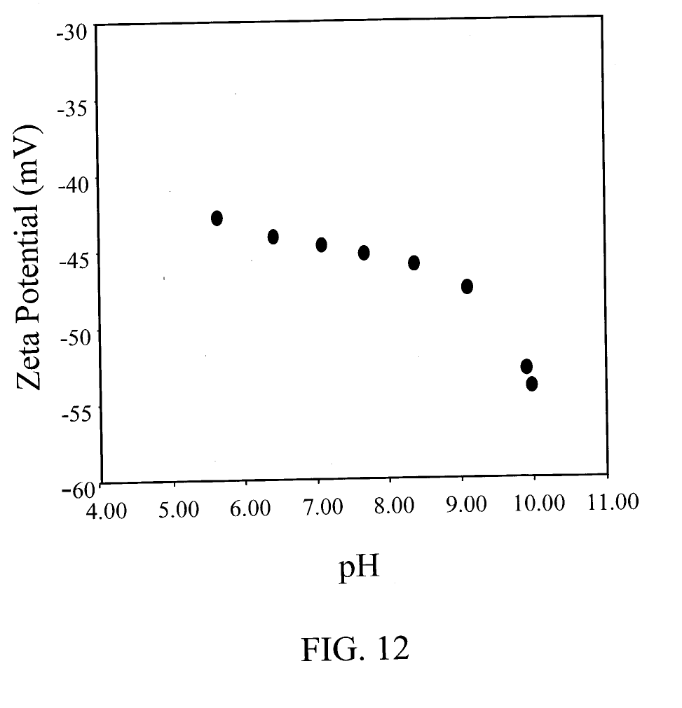

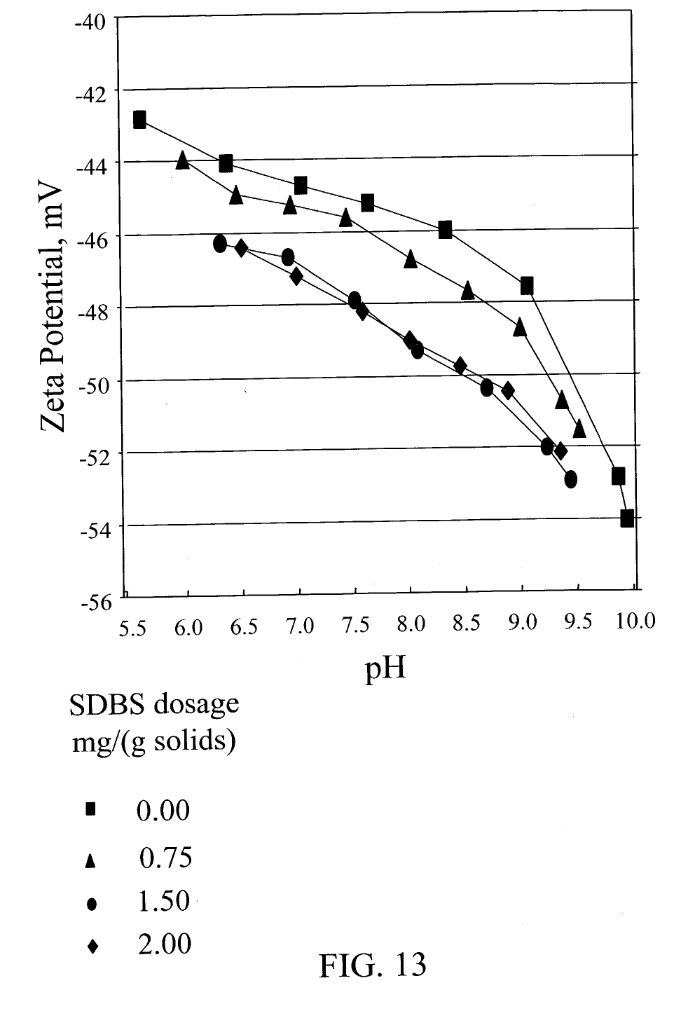

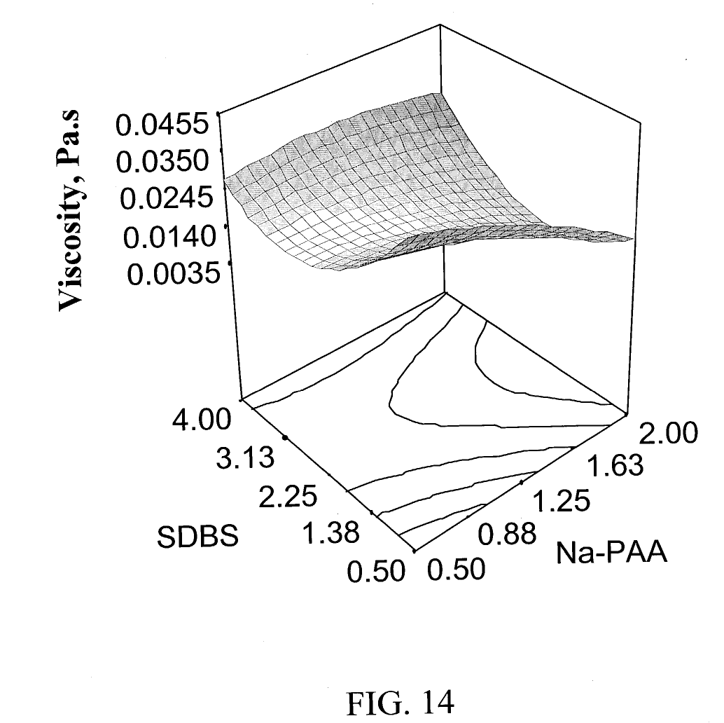

The colloidal stability of kaolin dispersions was studied through measurement of zeta potential of the samples at different conditions. Results indicate that all samples prepared in the presence of Na-PAA, SDBS, and the mixture of the two dispersing agents are colloidally stable. Typical plots of zeta (Smoluchowski) potential as a function of pH for dispersions of kaolin particles of 5% wt solids containing 2 mg/(g solids) of Na-PAA in the absence and presence of SDBS are shown in FIGS. 12 and 13. It can be observed that the magnitude of the zeta potential increases slightly as SDBS is added to the system. An increase in pH results in a more negative zeta potential suggesting a decrease in the number of positive sites on the particle edges. Since a negatively charged dispersing agent adsorbs onto the positive sites on the particle edges, there should consequently be a decrease in the adsorption density of the polymer at higher levels of pH as shown in FIG. 14. FIG. 14 is a plot of adsorption density of Na-PAA on the surface of kaolin as a function of the pH of the slurry.

### EXAMPLE 4

### Optimization: Response Surface Methods

Surface response methodology was employed to investigate the combined effect of the solids contents and dispersant dosages on shear viscosity of kaolin dispersions at different shear rates at a fixed pH level of 7.5. Experiments were conducted on kaolin slurries prepared in accordance with statistically designed experiments employing a Box Behnken method. The main variables of the design were solids content, Na-PAA dosage, and SDBS dosage. The advantage of this method over central composite design (CCD) is that all experimental points fall within the domain of the low and high levels of the design. While, in central composite design, axial points of the design may fall outside of the domain which in some cases may not be possible to prepare samples at extreme conditions (e.g, very high solids contents and/or zero level of dispersant dosage). The low and high levels of the design were: 1) solids content: 68 and 72% wt solids; 2) Na-PAA dosage: 0.5 and 2.0 mg/(g solids); and 3) SDBS dosage: 0.5 and 4.0 mg/(g solids). The range of independent variables was set to include the optimal dispersants dosages for minimal viscosity and the solids content that is used commercially.

Response surface methodology was used to study the relationship between the viscosity as the measured response to the input variables, which consist of solids content, and the dispersants dosages. With this technique, the effect of a given set of variables on a particular response can be studied, the setting of input variables that satisfies the desired specification can be recognized, and finally, the values of the inputs belonging to the stationary points of the response surface can be specified. To develop plots of the response surface and contours, the following general multiple linear regression model, which consists of the main effects, interactions, and quadratic terms, was used:

$$Y = {β}_{o} + {\sum }_{i = 1}^{3} {β}_{i} {X}_{i} + {\sum }_{i < j}^{3} {β}_{ij} {X}_{i} {X}_{j} + {\sum }_{i = 1}^{3} {β}_{ii} {X}_{i}^{2}$$

where Y is the estimate for the dependent variable (viscosity), and Xᵢ's are independent variables that are known for each experimental run. The constants βₒ, βᵢ, βᵢⱼ, and βᵢᵢ are the regression parameters. Xᵢ's are the linear (main) effect terms for each of the independent variables, Xᵢ Xⱼ's account for the two variable interactions, and the Xᵢ² terms indicate quadratic effects. The above model consists of three linear terms, three two variable interactions, three quadratic terms, and the constant βₒ, a total of ten parameters.

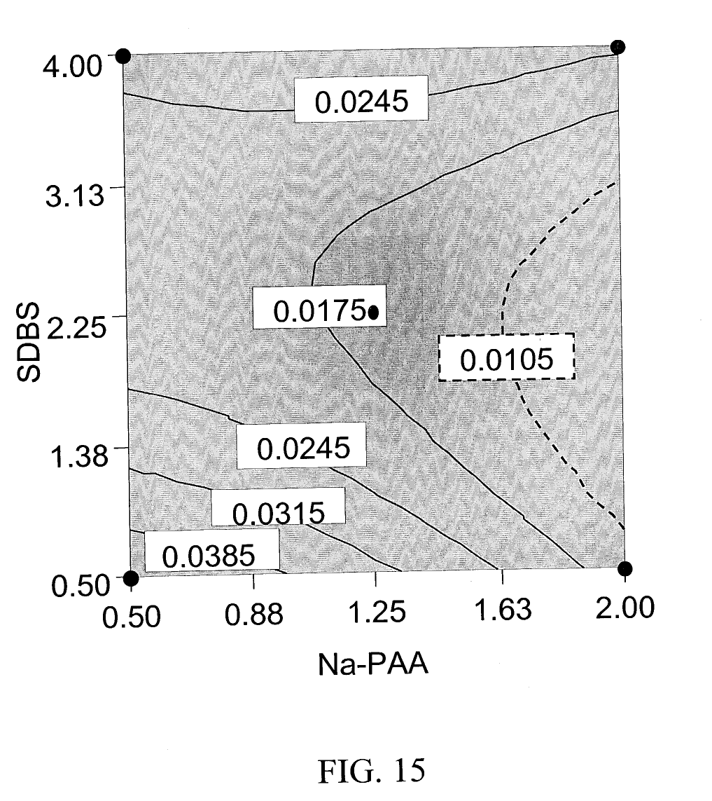

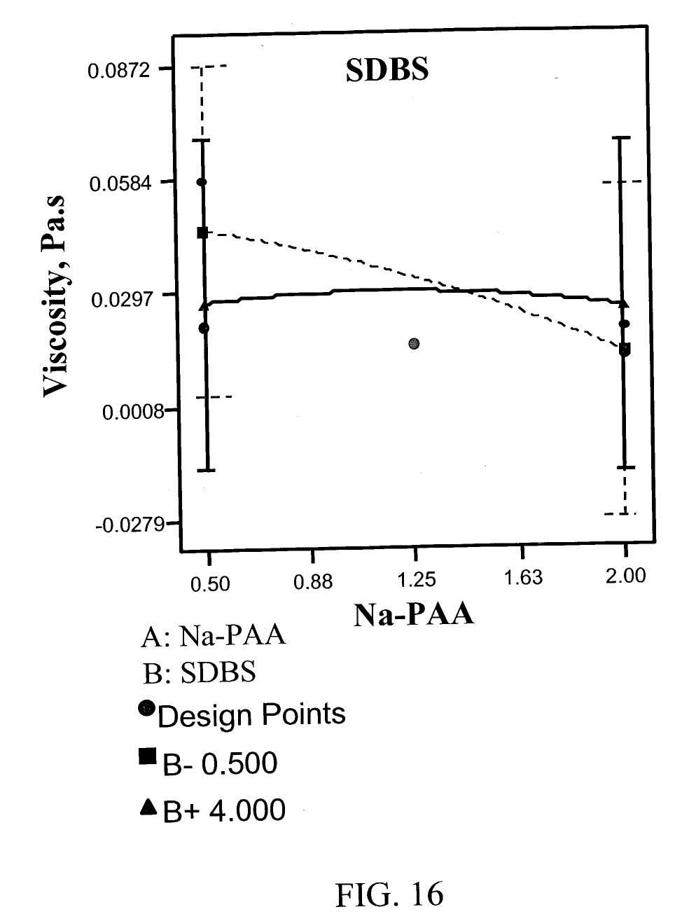

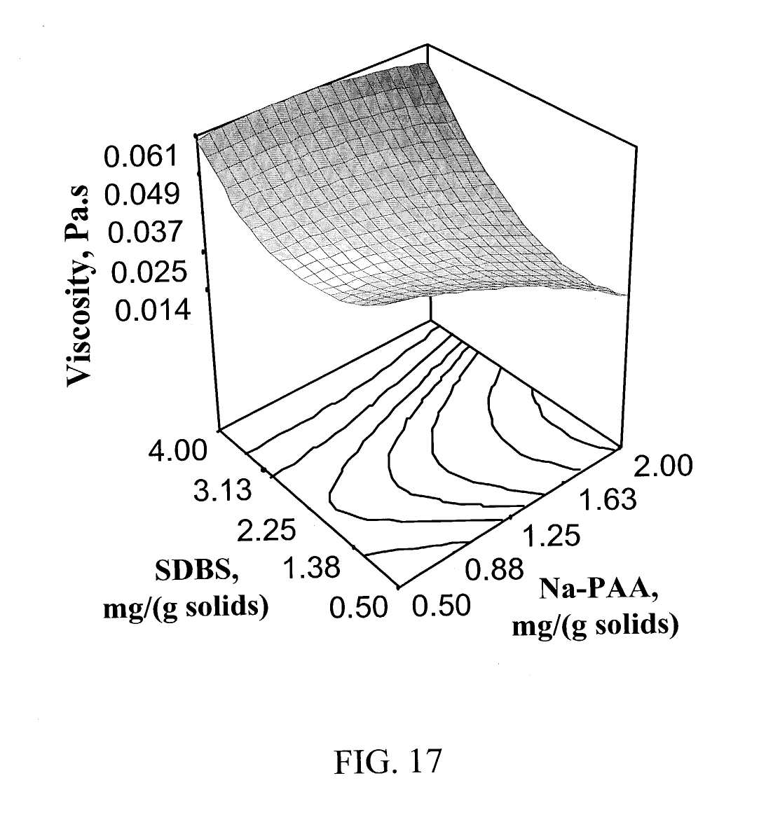

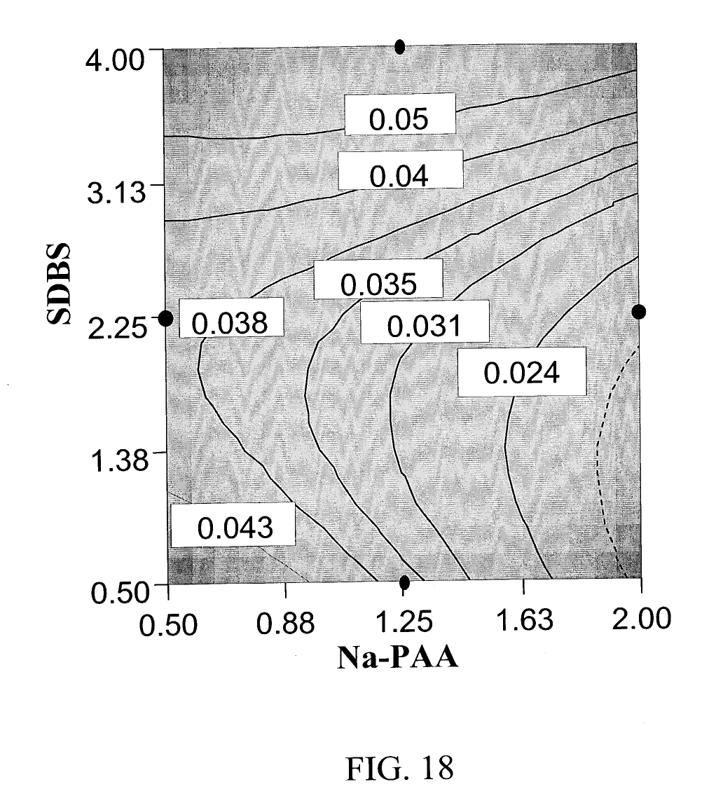

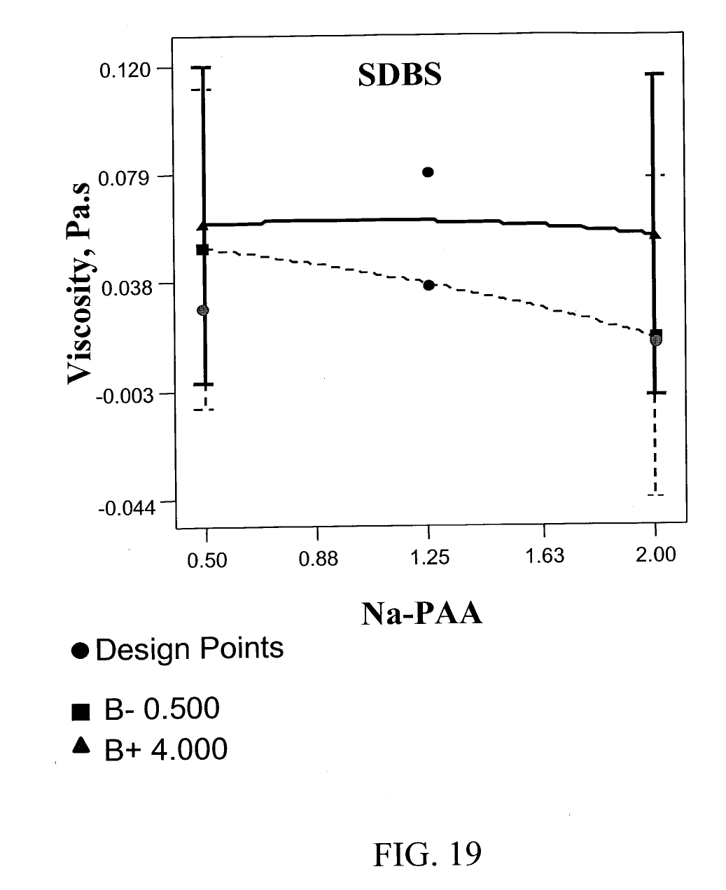

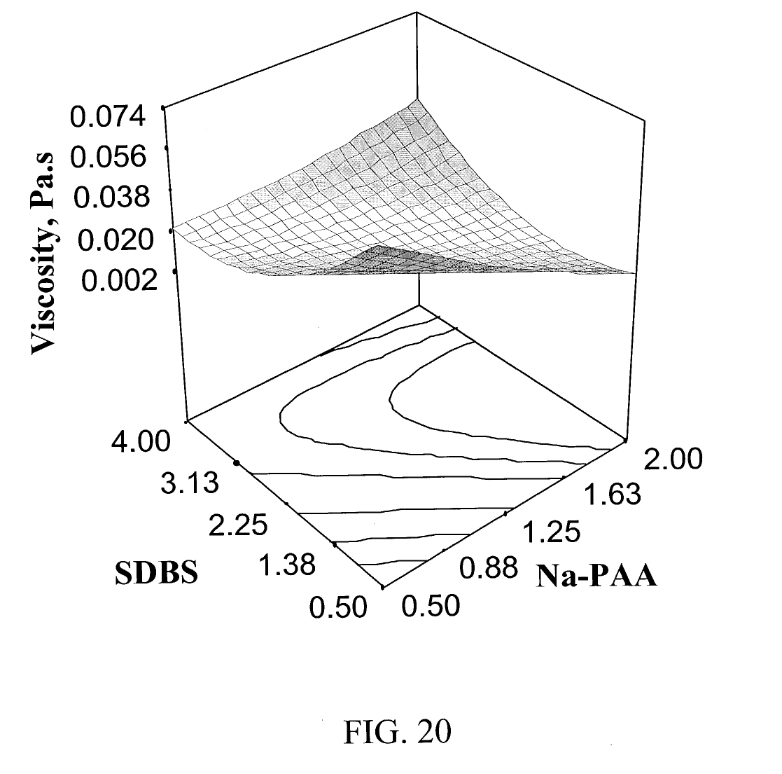

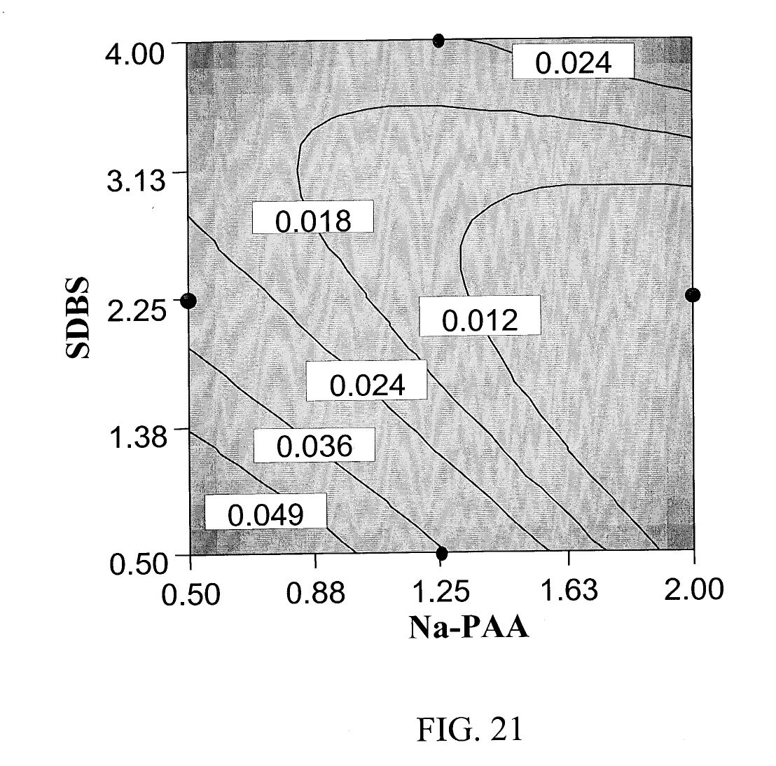

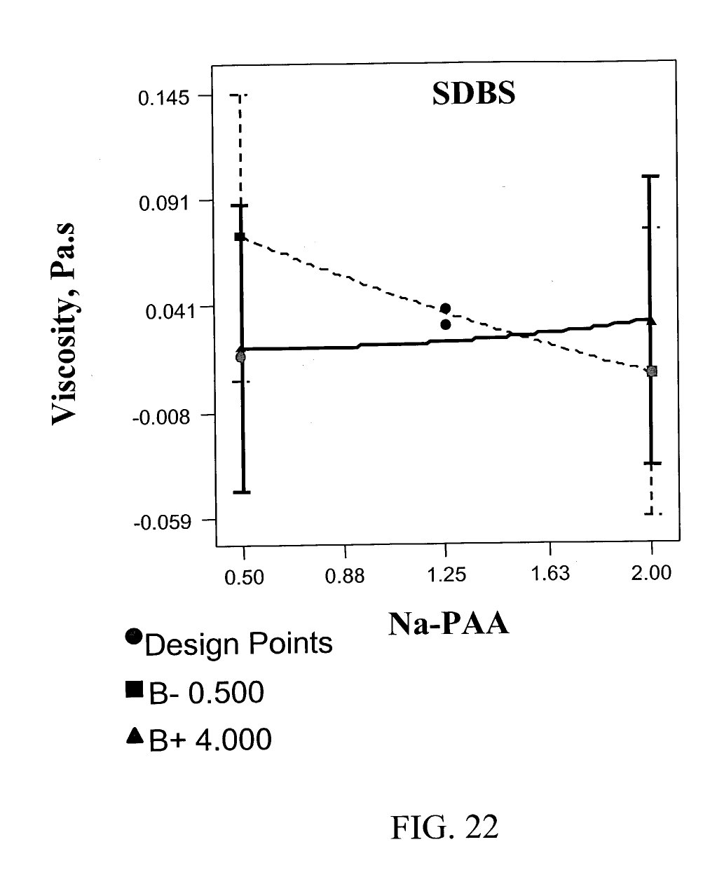

FIGS. 14 through 22 are examples of the response surfaces, their contour plots, and interaction plots for the effect of Na-PAA and SDBS dosages on the viscosity of kaolin at different solids contents and shear rates at a fixed level of pH=7.5. The data presented in these Figures are for kaolin dispersions at 70% wt solids and 72% wt solids at shear rates of 100 s⁻¹ and 5000 s⁻¹ as a function of Na-PAA and SDBS dosages. Over the range of independent variables studied, results indicate that at a fixed level of SDBS dosage, addition of Na-PAA to the dispersion reduces the viscosity of the system in general, but the level of viscosity reduction varies with the level of SDBS in the system. It appears that the level of viscosity reduction is more significant at lower SDBS dosages. At a fixed level of Na-PAA dosage, the viscosity of the dispersion will reduce through the addition of SDBS to the system and then starts to increase with further addition of SDBS to the dispersion.

It should be understood that the examples and embodiments described herein are for illustrative purposes only and that various modifications or changes in light thereof will be suggested to persons skilled in the art and are to be included within the spirit and purview of this application.

We claim:

1. A method for increasing the solids content in a colloidal dispersion of particles, wherein said method comprises adding to said dispersion an anionic surfactant in sufficient amounts to affect said increase in solids content compared to the colloidal dispersion in the absence of said surfactant.

2. The method, according to claim 1, which further comprises the addition of a dispersant to said colloid dispersion, wherein said dispersant is a polymer that adsorbs to said particles.

3. The method, according to claim 1, wherein said particles have positive surface charges.

4. The method, according to claim 1, wherein said particles have heterogeneous charges.

5. The method, according to claim 1, wherein said colloidal dispersion is a kaolin clay dispersion.

6. The method, according to claim 1, wherein the anionic surfactant is sodium dodecylbenzenesulphonate.

7. The method, according to claim 6, wherein about 2 to 4 mg of sodium dodecylbenzenesulphonate per gram of colloidal solid is added to the dispersion.

8. The method, according to claim 2, wherein the dispersant is a polyacrylate, or a salt thereof.

9. The method, according to claim 8, wherein the polymer is sodium polyacrylate.

10. The method, according to claim 9, wherein around 2 mg of sodium polyacrylate per gram of colloidal solid is added to the dispersion.

11. The method, according to claim 1, wherein said colloidal dispersion is selected from the group consisting of kaolin clays, calcium carbonates, silica particles, alumina particles, zirconia particles, bentonite clays, laponite clays, and montmorilonite clays.

12. A method for modifying high-shear rate properties of a colloidal dispersion of particles wherein said method comprises adding to said dispersion a polyacrylate and an anionic surfactant.

13. The method, according to claim 12, wherein the anionic surfactant is sodium dodecylbenzenesulphonate.

14. The method, according to claim 12, wherein said colloidal dispersion is selected from the group consisting of kaolin clays, calcium carbonates, silica particles, alumina particles, zirconia particles, bentonite clays, laponite clays, and montmorilonite clays.

15. The method, according to claim 14, wherein said colloidal dispersion is a kaolin clay dispersion.

16. A kit comprising a polyacrylate and an anionic surfactant in separate containers.

17. The kit, according to claim 16, which further comprises instructions for using the polyacrylate and anionic surfactant to modify the rheological properties of a dispersion.

18. The kit, according to claim 16, wherein the anionic surfactant is sodium dodecylbenzenesulphonate.
